(19) United States
(12) Patent Application Publication
(10) Pub. No.: US 2018/0223471 A1
(43) Pub. Date: Aug. 9, 2018

(54) Method for Treatment of Substrates

(71) Applicant: University of Leeds, Leeds (GB)

(72) Inventor: Stephen BURKINSHAW, Leeds (GB)

(73) Assignee: University of Leeds, Leeds (GB)

(21) Appl. No.: 15/504,338

(22) PCT Filed: Sep. 7, 2015
(86) PCT No.: PCT/GB2015/052687

§ 371 Date: Feb. 16, 2017

(30) Foreign Application Priority Data
Sep. 19, 2014 (GB) 1416545.0

(51) Int. Cl. D06L 4/657; D06P 1/38; D06P 1/39; D06P 1/41; D06P 1/60; D06P 1/00; D06P 1/62; D06P 1/96; C11D 11/00; C11D 3/37

(52) U.S. Cl. CPC D06L 4/657; D06P 1/38; D06P 1/39; D06P 1/41; D06P 1/60; C11D 3/3719; D06P 1/62; D06P 1/96; C11D 11/0017; C11D 3/3715; D06P 1/0008

(57) ABSTRACT

The invention provides a method for the application of a bleaching agent to a substrate, the method comprising the treatment of the substrate in an aqueous system comprising a liquid bleaching agent in a closed container, the treatment being carried out at a ratio of liquor to substrate which does not exceed 3:1. Typically, the method is applied to the bleaching of textile fibres and may optionally comprise a bleaching and scouring treatment. The invention also provides a method for the removal of surplus bleaching agents following the bleaching treatment, the method comprising not more than three aqueous wash-off treatments of the substrate. In addition to facilitating the use of much reduced liquor levels, the method also allows for significant reductions to be achieved in usage levels of bleaching agents, auxiliary agents and rinsing agents, thereby reducing generation of waste liquors requiring disposal. Furthermore, treatment temperatures are also significantly lower than for prior art methods, providing yet further benefits in environmental and cost terms.

### FIELD OF THE INVENTION

This invention relates to a new process for the treatment of substrates. More particularly, it provides a process for the bleaching of textile fibres which allows for significant reductions in the duration and temperature of bleaching processes as well as the quantities of water and auxiliaries employed in such processes.

### BACKGROUND TO THE INVENTION

Traditional bleaching processes of the type well known to those skilled in the art typically require the use of significant volumes of water. The bulk of the water present in these processes (>95%) is used for heating, rinsing, agitation, dissolution of chemicals and dispersion of the bleach. This heavy usage of water naturally has significant environmental implications in view of the limited water resources which are available and the requirement to subsequently treat contaminated waste. Self-evidently, there are also substantial associated cost implications in terms of energy, water and process equipment.

As is well known in the textile treatment industry, there are many processes available for the bleaching of very many different fibre types, typically requiring the application of bleaches to the textile fibres in the form of aqueous solutions or dispersions.

Amongst the fibre types treated by such processes are included natural fibres, such as wool, cotton and silk, and man-made fibres as exemplified by cellulose acetate and lyocell, as well as synthetic fibres, for example polyesters, polyamides such as nylon, polyalkenes and polyacrylonitrile. Various blends of different fibre types, such as polyester/cotton, wool/nylon and polyester/viscose/cotton, are also treated by such processes. Thus, for example, bleaching processes are typically used to reduce the yellowness of natural fibres, such as cotton, and to impart enhanced levels of whitenesss of the textile material.

Different conditions (pH, temperature, electrolyte; duration of treatment, liquor ratio, etc.) are currently used for the application of the various bleaching agents to the different types of fibre. Furthermore, different conditions may also be required for the application of bleaching agents to the (chemically) same textile fibre depending on the particular physical form in which it is processed, including, for example, yarns, hanks, open width fabric, garment, etc.

As noted above, conventional bleaching methods consume significant volumes of water (typical liquor ratios being in the range of ˜4-20:1 liquor ratio, depending on the type of fibre being treated); in addition, they typically employ large quantities of auxiliaries such as electrolytes, surfactants, alkalis, acids and other such materials and, thereby, generate massive quantities of wastewater which, depending on factors such as the type of bleach, fibre type and substrate construction being used, may contain residual bleach, electrolytes, acids, alkalis, and the like, and which can display marked recalcitrance towards biodegradation, thereby presenting both environmental and economic challenges. Indeed, many processes have been developed for the treatment and disposal of process wastewater, including traditional wastewater treatment methods such as adsorption, electrochemistry and oxidation, as well as nanofiltration, photocatalysis, irradiation and biosorption.

The present inventors have, therefore, sought to develop an approach that allows for significant reductions in the amount of water and auxiliaries, including various electrolytes, acids, alkalis and surfactants, which are used in the bleaching of substrates, especially textile fibres, and which also avoids the disadvantages associated with various alternative approaches which have previously been explored. Previously, in co-pending PCT Patent Application No. PCT/GB2014/050948, the inventors have disclosed a method for the application of a treatment agent to a substrate, the method comprising the treatment of the substrate in an aqueous system comprising the solid particulate treatment agent in a closed container, wherein the treatment is carried out at a ratio of liquor to substrate which does not exceed 2:1.

The previously disclosed method, however, relied on the initial introduction into the system of a solid particulate treatment agent. In the present application, on the other hand, the inventors have investigated the use of bleaching agents in liquid form, and have succeeded in providing a process that has produced results which are comparable in quality to conventional approaches to bleaching, but which allow for the use of very significantly reduced amounts of water; indeed, water levels are typically reduced to 10% of the water levels used in conventional processes. Specifically, the inventors have been successful in providing an improved treatment process by the use of liquid bleaching agents at low liquor ratios.

### SUMMARY OF THE INVENTION

Thus, according to the present invention, there is provided a method for the application of a bleaching agent to a substrate, said method comprising the treatment of the substrate in an aqueous system comprising a liquid bleaching agent in a closed container, said treatment being carried out at a ratio of liquor to substrate which does not exceed 3:1.

Optionally, said treatment may comprise the wetting out of the substrate using an aqueous liquor comprising said liquid bleaching agent, said wetting out being carried out at a ratio of liquor to substrate which does not exceed 3:1.

Optionally, said treatment may comprise spraying either one or both sides of said substrate with an aqueous liquor comprising said liquid bleaching agent so as to provide a ratio of liquor to substrate which does not exceed 3:1.

Optionally, said treatment may comprise the wetting out of the substrate with water and the subsequent treatment of the wetted out substrate with the liquid bleaching agent.

In certain embodiments of the invention, said ratio of liquor to substrate is in the range between 3:1 and 2:1. In certain embodiments of the invention, the ratio of liquor to substrate does not exceed 2.5:1. In specific embodiments of the invention, the ratio of liquor to substrate is 3:1, 2.5:1 or 2:1.

Said substrate may comprise any of a wide range of substrates, such as plastics materials, hair, rubber, paper, cardboard or wood. In typical embodiments of the invention, however, the substrate comprises a textile substrate, which may be a natural, man-made or synthetic textile substrate, or a substrate comprising a blend of natural, man-made and/or synthetic textile fibres. Natural textile substrates may, for example, include substrates comprising wool, cotton and/or silk. Typical man-made substrates are cellulose di- or tri-acetate, whilst synthetic textile substrates may comprise, for example, polyester, polyamide, polyalkene and/or polyacrylonitrile. A typical example of a natural/synthetic textile fibre blend would be a polyester/cotton substrate.

Suitable bleaching agents may include any of a range of liquid bleaches. Most particularly in the case of textile substrates, however, the method may be operated with particular success to apply a liquid bleaching agent which comprises or consists of hydrogen peroxide.

The liquid bleaching agent may be added to the treatment system at a wide range of agent:substrate ratios, but is typically added to the treatment system at a level in the region of 1-5% w/w of the substrate being treated, although greater or lesser amounts may be satisfactorily used. Thus, for example, satisfactory bleaching may be achieved with cotton at levels of about 2.5% w/w using hydrogen peroxide (50% w/w) or with polycotton at levels of about 1.5-2.5% w/w using H₂O₂ (35%).

Optionally, aqueous systems comprising said at least one liquid bleaching agent comprise at least one auxiliary agent. Most typically, systems comprising liquid bleaching agents comprise at least one auxiliary agent to facilitate increased bleaching efficiency and typically comprise agents selected from alkalis, wetting agents, detergents and sequestering agents.

In particular embodiments of the invention, said treatment with a bleaching agent may comprise a combined bleaching and scouring procedure, wherein said auxiliary agents may comprise agents which promote scouring, such as non-ionic surfactants In embodiments of the invention said auxiliary agents may comprise or include stabilising agents, for example sodium silicate. In these embodiments the stabilising agent can be a stabiliser for the bleaching system.

Said at least one auxiliary agent may be provided as a solid particulate material or as an aqueous liquor. Most conveniently, especially in embodiments of the invention wherein an aqueous liquor comprising said liquid bleaching agent is applied to a substrate by means of wetting out or spraying procedures, said auxiliary agent is also provided as an aqueous liquor; typically, said auxiliary agent is comprised in the aqueous liquor comprising the liquid bleaching agent, but it may be comprised in a separate aqueous liquor.

In embodiments of the invention wherein the substrate is treated with an aqueous liquor comprising said liquid bleaching agent and said auxiliary agent, said auxiliary agent may be present in said aqueous liquor in partially or wholly dissolved or suspended form.

The auxiliary agent is added at a level appropriate to the bleaching process which is being performed. Thus, for example, wetting agents, detergents and sequestering agents may be added at a combined level in the region of 0.5-20.0 gL⁻¹, most typically in the region of 2-10 gL⁻¹, whilst alkaline agents are included in amounts of 1-30 gL⁻¹, with particularly good results being observed at addition levels of around 2-20 gL⁻¹.

Although the use of auxiliary agents is frequently beneficial in procedures according to the invention, the disclosed method does provide another significant advantage over the conventional bleaching procedures of the prior art, in that the method described herein is carried out in the presence of significantly reduced amounts of these materials.

In certain embodiments the aqueous system of the invention comprises at least one surfactant.

In certain embodiments of the invention the bleaching agent is not derived or does not originate from a solid particulate material present in the aqueous system. In such embodiments the bleaching agent may not thus be transferred or transported into the aqueous system following the dissolution or partial dissolution of a solid particulate material comprising a bleaching agent.

In certain embodiments of the invention the aqueous system is substantially free from one or more foaming agents.

In particular embodiments of the invention the aqueous system may be substantially free from one or more foaming agents selected from the list consisting of: anionic foaming agents such as partially carboxymethylated alkylpolyglycolethers, arylpolyglycolethers, alkylarylpolyglycolethers or arylalkylpolyglycolethers, alkanesuplhonates, alkylbenzenesulponates and alkylnaphthalene sulphonates, primary or secondary alkylsulphates, alkylpolyglycol-ether sulphates, alkyl-phenylpolyglycol-ether sulphates and dialkylphenylpolyglycol-ether sulphates, sulphonated or sulphated oils, fatty acid taurides and fatty acid-sulphato-ethylamides; non-ionic agents such as water-soluble adducts obtained by reacting 8 to 50 moles of ethylene oxide with a fatty alcohol, a fatty acid, a fatty acid amide, an alkylmercaptan or an alkylphenol (e.g nonyl-, decyl or undecylphenol); cationic agents such as the adducts obtained by reacting 8 to 100 moles of ethylene oxide with a fatty alkylamine or a fatty alkylpoly-amide or their quaternized derivatives; or amphoteric agents such as fatty acid-sulphato-ethylamino-ethylamides, fatty acid γ-sulpho-β-hydroxy-propylamino-ethylamides, the monosulphated or disulphated adducts of 8 to 100 moles of ethylene oxide and a fatty alkylamine or a fatty alkylpolyamine.

In certain embodiments of the invention the term “substantially free from one or more foaming agents” can refer to the presence of less than 0.1 gram per litre and preferably less than 0.05 gram per litre of said one or more foaming agents within the aqueous system.

In certain embodiments of the invention the aqueous system can be substantially free from compounds of the formula (I):

R—O—(C₃H₆O)ₙ—(C₂H₄₀)ₘ—H (I)

wherein n is 0 or a number between 1 and 4, m is a number between 2 and 10 and R stands for a C₈-C₁₅ alkyl group, the group comprising at least one carbon atom which is directly connected to three other carbon atoms.

In certain embodiments of the invention the term “substantially free from compounds of the formula (I)” can refer to the presence of quantities of compounds of the formula (I) of less than 10 ml per kg of substrate and preferably less than 1 ml per kg of substrate within the aqueous system.

The method of the invention is typically carried out at ambient or elevated temperature which may suitably fall in the range of from 20° to 140° C. Particularly favourable results have been achieved using temperatures in the region of 60° to 85° C. In certain embodiments the method of the invention can be carried out at temperatures in the range of 20° to 100° C., 20° to 95° C., 20° to 90° C., 20° to 85° C. or 20° to 80° C.

Said treatment method is carried out in a closed container which may include, for example, a sealed dyepot or other suitable sealable dyeing or fabric treatment apparatus. The container may be formed from any suitable material but, most conveniently, it comprises a metal (e.g. stainless steel) or plastic (e.g. polypropylene) container. The use of a closed system in this way allows for the generation of a low pressure water vapour environment when the temperature of the system is elevated above the ambient. Without wishing to be bound by theory, the inventors believe that the water vapour produced in this way further dampens and swells the substrate, and is particularly effective in so doing in the case of textile fibres. It is considered that the water vapour environment aids diffusion of the liquid bleaching agent and any auxiliary agents (e.g. alkalis, wetting agents, detergents or sequestering agents) within the textile material and also promotes uniform sorption of the bleaching agent and any auxiliary agents across the substrate.

In certain embodiments the closed container does not comprise a squeezing device that is adapted to squeeze liquor from the substrate.

In certain embodiments the closed container does not comprise a gas nozzle configured to deliver a gas stream to the substrate during the or after the treatment process.

Advantageously, the aqueous system containing the substrate is agitated, typically in a random manner, during the performance of the method of the invention. Typically, treatments according to the method of the invention are carried out by maintaining the selected optimum bleaching temperature for a duration of between 10 and 60 minutes, with favourable results generally being achieved in 30 minutes or less, although the duration of combined bleaching and scouring procedures is usually somewhat longer, and nearer 60 minutes.

Typically, the method of the present invention additionally includes a rinsing procedure for the removal of surplus bleaching and other agents following application of said agents to a substrate, said rinsing procedure comprising not more than three rinse treatments of said substrate with aqueous liquor following said application.

In typical embodiments of the method of the invention, said rinsing procedure comprises a three-stage process comprising performing, in order, the steps of:
(a) A first rinse of the bleached substrate with aqueous liquor in a closed container;
(b) A second rinse of the bleached substrate with aqueous liquor in a closed container; and
(c) A final rinse of the bleached substrate with aqueous liquor in a closed container.

In typical embodiments of the invention the ratio of liquor to substrate does not exceed 5:1 in any of steps (a), (b) or (c). In embodiments of the invention wherein the treatment with a bleaching agent additionally comprises a scouring treatment, the ratio of liquor to substrate does not exceed 10:1 in any of steps (a), (b) or (c); typically, ratios of 10:1 are used in the first and third rinses, whilst much lower ratios, not exceeding 5:1, typically as low as 2:1, may be used for the second rinse.

According to the methods of the prior art, liquor ratios of at least 10:1 are generally employed in such three stage rinsing procedures in order to achieve removal of excess treatment agents so, again, a reduction in liquor requirements is demonstrated.

Typically, the rinsing steps are carried out at temperatures in the region of ambient (20° C.) to 75° C., whilst the duration of each rinsing step is typically in the region of from 2-10 minutes. In certain embodiments of the invention, the first two rising steps are carried out for about 10 minutes, whilst the final rinsing step is performed for around 5 minutes but, in some embodiments, the duration of each of the rinsing steps may be as little as 2 minutes.

In embodiments of the invention, the aqueous liquors used for each of the rinsing stages may consist of water, typically tap water. Alternatively, said aqueous liquors may optionally include at least one rinsing agent. Suitable rinsing agents are consistent with those which are known from the prior art, and may typically be selected from neutralising agents, which most conveniently may be acids, and bleach removers, which are able to remove or destroy remaining excess bleaching agents. Said rinsing agents may be applied together in the same rinsing stage but are advantageously applied separately in different rinse stages.

In certain embodiments of the invention, the separate rinse stages may include rinsing with water, rinsing with an aqueous liquor containing a neutralising agent and rinsing with an aqueous liquor containing a bleach remover. Typically, said rinsing stages may be carried out in the stated order.

Suitable examples of neutralising agents include acids, which may be selected from mineral acids and organic acids. A particularly suitable neutralising agent is acetic acid.

Suitable bleach removers are selected in the context of the liquid bleaching agent which is employed. In the case of a liquid bleaching agent which comprises hydrogen peroxide, said bleach remover could typically comprises an agent which catalyses peroxide decomposition, such as an enzyme.

The rising agents are added at levels appropriate to achieve effective removal of excess bleaching agent and auxiliary agents from the bleached substrate. Thus, for example, neutralising agents may be added at a level in the region of 0.1-5.0 gL⁻¹, most typically in the region of 0.5-1.0 gL⁻¹, whilst bleach removers are included in amounts of 1-10 gL⁻¹, with particularly good results being observed at addition levels of around 3.5 gL⁻¹.

The rinsing procedure may be again be applied to the post-bleach rinsing of a wide range of substrates, such as plastics materials, hair, rubber, paper, cardboard or wood, which may have been subjected to a bleaching treatment but, again, is most typically applied to the wash-off of textile substrates following bleaching.

Once more, therefore, the method of the invention provides further significant advantages over the conventional procedures of the prior art, in that the rinsing procedures described herein are carried out in the presence of significantly reduced amounts of these rinsing agents in view of the much lower liquor ratios which are employed. The rinsing procedures used with conventional textile bleaching processes routinely employ large liquor ratios (i.e. commonly 8-20:1), on occasions also requiring the use of additional rinsing stages which consume large volumes of water. Hence, conventional post-bleaching rinsing processes generate large volumes of wastewater that typically contain residual bleaches, surfactants, electrolytes, etc., all of which characteristically display marked recalcitrance towards biodegradation, thereby presenting both environmental and economic challenges. By way of contrast, the volumes resulting from the present rinsing method are very much lower.

It will also be appreciated that the temperature of the treatment method according to the present invention is also significantly lower than for prior art methods, providing yet further benefits in terms of environmental and cost considerations, whilst the lower requirements terms of quantities of various additives required for both the bleaching and rinsing processes offers yet further advantages.

The method of the present invention may be used for either small or large scale processes which may be batchwise, continuous or semi-continuous processes.

### BRIEF DESCRIPTION OF THE DRAWINGS

Embodiments of the invention are further described hereinafter with reference to the accompanying drawings, in which:

FIG. 1 is a method profile for the bleaching of cotton using hydrogen peroxide at a liquor ratio according to a method of the prior art;

FIG. 2 is a method profile for a conventional rinsing procedure for cotton which has been bleached using hydrogen peroxide according to a method of the prior art;

FIG. 3 is a method profile for the bleaching of cotton using hydrogen peroxide according to an embodiment of the method of the invention;

FIG. 4 is a method profile for a modified rinsing procedure for cotton which has been bleached using hydrogen peroxide according to an embodiment of the method of the invention;

FIG. 5 is a method profile for the bleaching of cotton using hydrogen peroxide according to a further embodiment of the method of the invention;

FIG. 6 is a method profile for the application of C.I. Reactive Black 5 to cotton which has been bleached using hydrogen peroxide according to an embodiment of the method of the invention; and

FIG. 7 is a method profile for a wash off procedure employed following the application of C.I. Reactive Black 5 to cotton which has been bleached using hydrogen peroxide according to an embodiment of the method of the invention.

FIG. 8 is a method profile for the bleaching and scouring of cotton using hydrogen peroxide at a liquor ratio according to a method of the prior art

FIG. 9 a method profile for a conventional rinsing procedure for cotton which has been bleached using hydrogen peroxide according to a method of the prior art

FIG. 10 is a method profile for the bleaching and scouring of cotton using hydrogen peroxide according to an embodiment of the method of the invention

FIG. 11 is a method profile for a modified rinsing procedure for cotton which has been bleached using hydrogen peroxide and scoured, according to an embodiment of the method of the invention;

FIG. 12 is a method profile for the bleaching of cotton using hydrogen peroxide at a liquor ratio according to a method of the prior art;

FIG. 13 is a method profile for the bleaching of cotton using hydrogen peroxide according to an embodiment of the method of the invention; and

FIG. 14 is a method profile for the bleaching of cotton using hydrogen peroxide according to an embodiment of the method of the invention.

### DESCRIPTION OF THE INVENTION

In specific embodiments of the present invention, non wetted-out textile materials may be treated by either spraying or immersing the substrate with an aqueous liquor which comprises the liquid bleaching agent and, if appropriate, at least one auxiliary agent. The amount of the aqueous liquor applied to the textile substrate is typically such as to achieve a substrate to liquor ratio of about 2:1. The treated textile material is typically placed in a container which is then sealed. The container is of appropriate ullage to enable an adequate level of movement of the damp, treated substrate and the development of a water vapour environment within the sealed container. The sealed container is then agitated in a suitable machine at the appropriate temperature until bleaching is achieved, which typically would take around 30 minutes. Suitable sealed containers may, for example, include stainless steel dyepots or plastic containers, such as polypropylene bags.

A particularly suitable liquid bleaching agent for application to textile substrates is hydrogen peroxide.

The liquid bleaching agent is typically added at a level in the region of 1-5% w/w of the substrate being treated, and satisfactory bleaching of cotton can in some embodiments be achieved at levels of about 2.5% w/w using hydrogen peroxide (50% w/w) and in some embodiments with polycotton at levels of about 1.5-2.5% w/w using H₂O₂ (35%).

In embodiments of the invention, at least one auxiliary agent is added to the bleaching composition, with typical auxiliary agents being selected from alkalis, wetting agents, detergents and sequestering agents. In particular embodiments of the invention said auxiliary agents may comprise agents which promote scouring, such as non-ionic surfactants, and stabilising agents, for example sodium silicate. The stabilising agent can be a stabiliser for the bleaching system.

Said auxiliary agents are most conveniently comprised in the aqueous liquor comprising the liquid bleaching agent, and wetting agents, detergents and sequestering agents are typically added at a combined level in the region of 0.5-20.0 gL⁻¹, most typically in the region of 2-10 gL⁻¹, whilst alkaline agents are included in amounts of 1-30 gL⁻¹, with particularly good results being observed at addition levels of around 2-20 gL⁻¹.

In certain embodiments of the invention, suitable alkalis may be selected from, for example, sodium hydroxide, potassium hydroxide, sodium carbonate and potassium carbonate.

In certain embodiments of the invention, commercially available bleaching auxiliaries which comprise combined wetting agents, detergents and sequestering agents may conveniently be employed in the method of the invention. A suitable example of such a material is Imerol® Blue (an anionic bleaching auxiliary available from Clariant Ltd.) An example of a suitable scouring additive is Sandozin N/N (a non-ionic surfactant available from Clariant Ltd.), which is conveniently used together with a stabiliser such as sodium silicate.

In certain embodiments of the invention the aqueous system can be substantially free from one or more foaming agents or specific foaming agents. In particular embodiments of the invention, the aqueous system may be substantially free from one or more anionic foaming agents including aliphatic and/or aromatic carboxylic and sulphonic acids, their esters or amides or araliphatic sulphates and phosphates. In specific embodiments, the aqueous system may be substantially free from one or more anionic foaming agents such as partially carboxymethylated alkylpolyglycolethers, arylpolyglycolethers, alkylarylpolyglycolethers or arylalkylpolyglycolethers, alkanesulphonates, alkylbenzene sulphonates and alkylnaphthalene sulphonates, primary or secondary alkylsulphates, alkylpolyglycol-ether sulphates, alkyl-phenylpolyglycol-ether sulphates and dialkylphenylpolyglycol-ether sulphates, sulphonated or sulphated oils, fatty acid taurides and fatty acid-sulphato-ethylamides.

Alternatively, or in addition, the aqueous system of the invention may be substantially free from one or more non-ionic foaming agents. In specific embodiments, the aqueous system may be substantially free from one or more non-ionic foaming agents such as water-soluble adducts obtained by reacting 8 to 50 moles of ethylene oxide with a fatty alcohol, a fatty acid, a fatty acid amide, an alkylmercaptan or an alkylphenol (e.g nonylphenol, decylphenol or undecylphenol).

Alternatively, or in addition, the aqueous system the aqueous system of the invention may be substantially free from one or more cationic foaming agents. In specific embodiments, the aqueous system may be substantially free from one or more cationic foaming agents such as the adducts obtained by reacting 8 to 100 moles of ethylene oxide with a fatty alkylamine or a fatty alkylpoly-amide or their quaternized derivatives.

Alternatively, or in addition, the aqueous system the aqueous system of the invention may be substantially free from one or more amphoteric foaming agents. In specific embodiments, the aqueous system may be substantially free from one or more cationic amphoteric foaming agents such as fatty acid-sulphato-ethylamino-ethylamides, fatty acid γ-sulpho-β-hydroxy-propylamino-ethylamides or the monosulphated or disulphated adducts of 8 to 100 moles of ethylene oxide and a fatty alkylamine or a fatty alkylpolyamine.

The term “substantially free from one or more foaming agents” refers to the presence of less than 0.1 gram per litre and preferably less than 0.05 gram per litre of any of the above foaming agents within the aqueous system.

In embodiments of the invention, bleaching is typically carried out at temperatures between 70° and 100° C. Particular embodiments of the invention have involved bleaching treatments which have been performed at 98° C. in sealed dye pots and at 74° C. in sealed polypropylene bags. Further embodiments have involved combined bleaching and scouring processes which have been carried out at 80° C. and 98° C. in sealed dye pots. In certain embodiments the method of the invention can be carried out at temperatures in the range of 20° to 100° C., 20° to 95° C., 20° to 90° C., 20° to 85° C. or 20° to 80° C.

Advantageously, the aqueous system containing the substrate is agitated, typically in a random manner, during the performance of the method of the invention. Agitation is typically achieved using a suitable agitation device. Thus, for example, in the case of dye pots, agitation is conveniently carried out in a dyeing machine, such as a Roaches Pyrotec® S, whilst agitation of polypropylene bags is most effectively carried out using a device such as a commercially available tumble dryer, for example a Miele® PT8257.

Typically, treatments according to the method of the invention are carried out by maintaining the optimum bleaching temperature for a duration of between 10 and 60 minutes, with favourable results generally being achieved in around 30 minutes. The optimum bleaching temperature can be within any of the temperature ranges mentioned above. In embodiments of the invention, the bleaching system is suitably heated to the optimum temperature in a gradual fashion, ideally at a rate of around 2° C. per minute; following completion of the bleaching cycle, cooling is similarly effected at a gradual rate, which may conveniently be around 3° C. per minute. Following cooling, typically to around 50° C., the substrate may be squeezed to remove excess liquor.

Thus, it is seen that the disclosed process is extremely simple and efficient, and the invention facilitates the bleaching of all types of textile fibres in a wide range of physical forms at a typical liquor ratio of 2:1 at significantly lower liquor ratios than the methods of the prior art.

On completion of the bleaching treatment according to the method of the invention, the treated substrate is typically rinsed using conventional post-bleach rinsing agents well known in the art. However, as in the bleaching process, water usage levels during rinsing are correspondingly low.

A typical rinsing procedure comprises a three-stage process comprising performing, in order, the steps of:
(a) A first rinse of the bleached substrate with aqueous liquor in a closed container;
(b) A second rinse of the bleached substrate with aqueous liquor in a closed container; and
(c) A final rinse of the bleached substrate with aqueous liquor in a closed container.

In typical embodiments of the invention the ratio of liquor to substrate does not exceed 5:1 in any of steps (a), (b) or (c). In embodiments of the invention wherein the treatment with a bleaching agent additionally comprises a scouring treatment, the ratio of liquor to substrate does not exceed 10:1 in any of steps (a), (b) or (c); typically, ratios of 10:1 are used in the first and third rinses, whilst much lower ratios, not exceeding 5:1, typically as low as 2:1, may be used for the second rinse.

In certain embodiments of the invention, the rinsing steps are carried out at a temperature in the region of 65° C., typically, the duration of each of the first two rinsing steps is in the region of 10 minutes, whilst the final rinsing step is performed for around 5 minutes. Excess liquor is drained off after each of the first two steps, and the substrate is then squeezed and dried following the third of the rinsing steps.

In some embodiments of the invention involving bleaching and scouring, the rinsing steps are carried out at around room temperature and the duration of each of the rinsing steps is typically in the region of 2 minutes. The substrate is then squeezed to remove excess liquor after each of the first two steps, and then dried following the third of the rinsing steps.

In embodiments of the invention, the first rinse step comprises rinsing with water, whilst the second rinse step involves rinsing with an aqueous liquor containing a neutralising agent and the third rinse step comprises rinsing with an aqueous liquor containing a bleach remover.

Suitable neutralising agents include mineral acids and organic acids, a particularly suitable example of which is acetic acid.

A particularly suitable bleach remover for use in the context of a liquid bleaching agent which comprises hydrogen peroxide is an agent which catalyses peroxide decomposition, such as an enzyme, a specific example of which is Bactosol® SAP (available from Clariant Ltd.).

Suitable addition levels for the neutralising agents are typically in the region of 0.1-5.0 gL⁻¹, most typically around 0.5-1.0 gL⁻¹, whilst bleach removers are generally included in amounts of 1-10 gL⁻¹, with particularly effective results being observed at levels of around 3.5 gL⁻¹.

Whilst the method of the invention is most typically applied to the bleaching of textile materials, it is applicable to any of a wide range of substrates, such as plastics materials, hair, rubber, paper, cardboard or wood. Most frequently, however, the substrate comprises a natural, man-made or synthetic textile substrate, or a substrate comprising a blend of natural, man-made and/or synthetic textile fibres.

As a consequence of the low levels of bleaching agents, auxiliary agents and rinsing agents that are required when using the method of the invention, generation of waste liquors requiring disposal is significantly reduced. As previously observed, it is believed that the success of the method of the invention is attributable to the generation, even at comparatively low temperatures, of sufficient water vapour and water vapour pressure within the sealed container to facilitate the diffusion of the liquid bleaching agent and any auxiliary agents within the textile material and also to promote uniform sorption of the bleaching agent and any auxiliary agents across the substrate.

The claimed invention will now be further illustrated, though without in any way limiting the scope of the disclosure, by reference to the following examples.

### EXAMPLES

In seeking to exemplify the method of the invention, the inventors compared the results achieved when cotton was bleached according to the method of the invention using a liquor ratio of 2:1 at temperatures of 74° C. and 98° C. with the results observed by bleaching cotton using a conventional procedure at a liquor ratio of 10:1 and a temperature of 98° C. The low liquor ratio process carried out at 98° C. was performed in stainless steel dye tubes, whilst the process which used a temperature of 74° C. utilised sealed bags housed in a tumble dryer. The conventional bleaching process followed a procedure recommended by Clariant Ltd., and the same bleaching auxiliaries (all supplied by Clariant Ltd.) were used in all processes.

The effects achieved by both the conventional and low liquor ratio processes were evaluated by measurement of the Whiteness Index (WI) of the bleached fabrics, and by determining both the Water Absorbency (WA) and dyeability of the bleached fabrics. The results obtained when using each of the low liquor ratio processes and the conventional process were then compared.

The inventors also compared the results achieved when polyester/cotton was subjected to a combined bleaching and scouring process according to the method of the invention using liquor ratios of 2:1 and 3:1 at temperatures of 80° C. and 98° C. with the results observed by bleaching and scouring cotton using a conventional procedure at a liquor ratio of 10:1 and a temperature of 98° C. The same bleaching agents and auxiliaries (all supplied by Clariant Ltd.) were used in all processes.

### A. Bleaching Procedures

### Materials

Scoured woven cotton greige fabric obtained from Whaleys (Bradford, UK) was used in all the tests. As noted above, the bleaching auxiliaries and rinsing agents are obtained from Clariant, and details are set out in Table 1.

TABLE 1
AUXILIARY BLEACHING AND RINSING AGENTS

| Trade Name | Type |
|---|---|
| Bactosol ® SAP | Hybrid Catalase Enzyme; Catalyses Peroxide |
| | Decomposition |
| Imerol ® Blue | Bleaching Auxiliary; Combined Wetting Agent, |
| | Detergent and Sequestering Agent |

### Comparative Example 1

Conventionally bleached examples were obtained by carrying out bleaching operations in sealed, 300 cm³ capacity, stainless steel dyepots housed in a Roaches Pyrotec S dyeing machine.

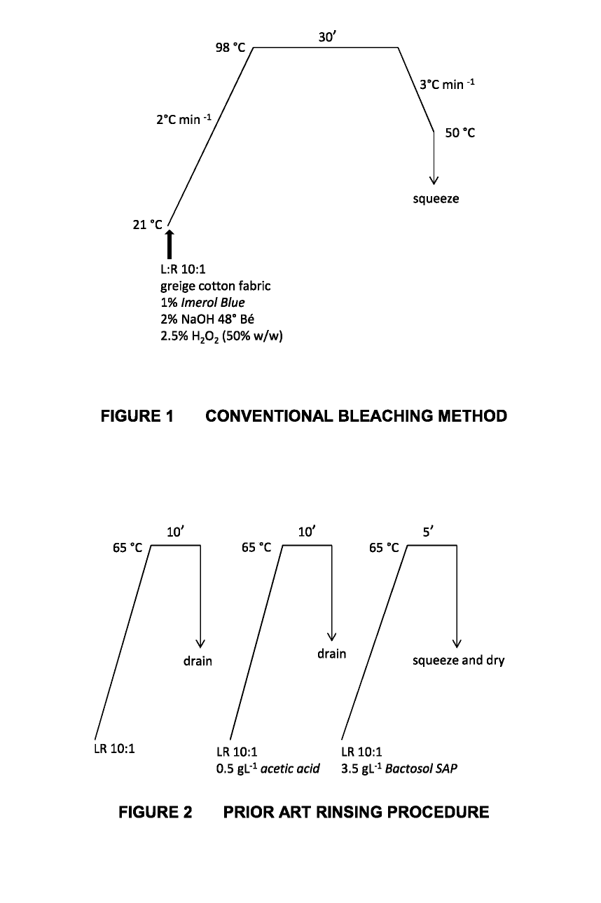

Greige fabric was bleached using the procedure shown in FIG. 1, employing a solution comprising 1% Imerol® Blue, 2% NaOH 48 Be and 2.5% H₂O₂ (50% w/w) at a 10:1 liquor ratio. At the conclusion of the bleaching process, the sample was removed from the process bath, squeezed to remove surplus liquor and subjected to the rinsing procedure shown in FIG. 2, employing a liquor ratio of 10:1 for each of the three rinsing stages. The rinsed samples were squeezed and allowed to dry in the open air.

### Example 1

In this procedure, bleaching was carried out in sealed, 300 cm³ capacity, stainless steel dyepots housed in a Roaches Pyrotec S dyeing machine.

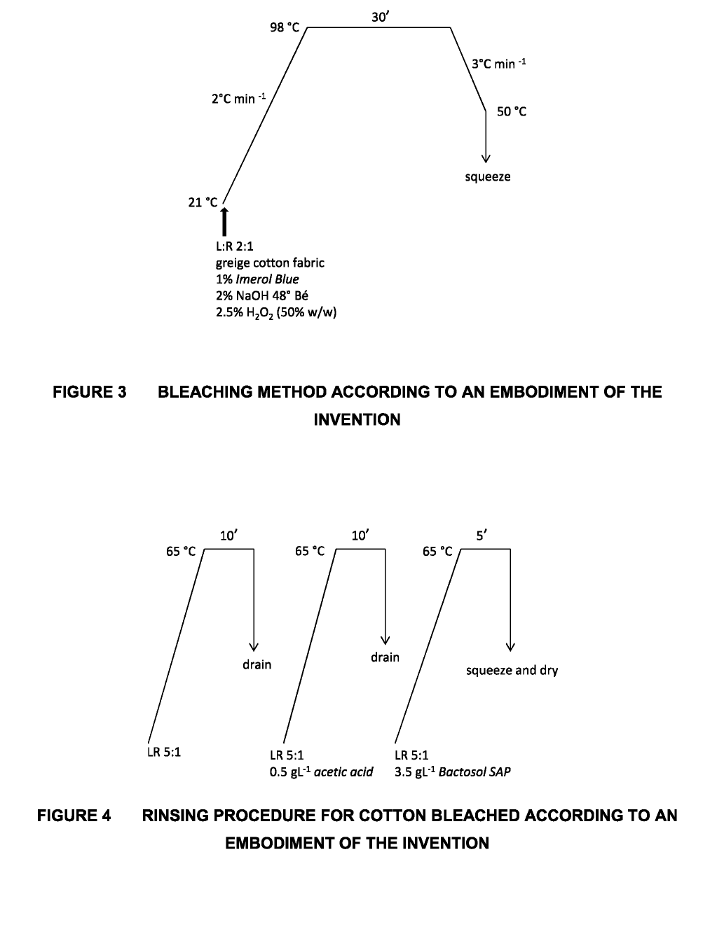

Greige fabric was bleached using the procedure shown in FIG. 3, employing a solution comprising 1% Imerol® Blue, 2% NaOH 48 Be and 2.5% H₂O₂ (50% w/w) at a 2:1 liquor ratio. At the conclusion of the bleaching process, the sample was removed from the process bath, squeezed to remove surplus liquor and subjected to the rinsing procedure shown in FIG. 4, employing a liquor ratio of 5:1 for each of the three rinsing stages. The rinsed samples were squeezed and allowed to dry in the open air.

### Example 2

In this procedure, bleaching was carried out in a sealed, 1000 cm³ capacity, polypropylene plastic bag housed in a Miele® PT8257 tumble dryer. Prior to bleaching, the greige fabric was wetted-out with the bleaching solution which resulted in a water:fabric ratio of 2:1.

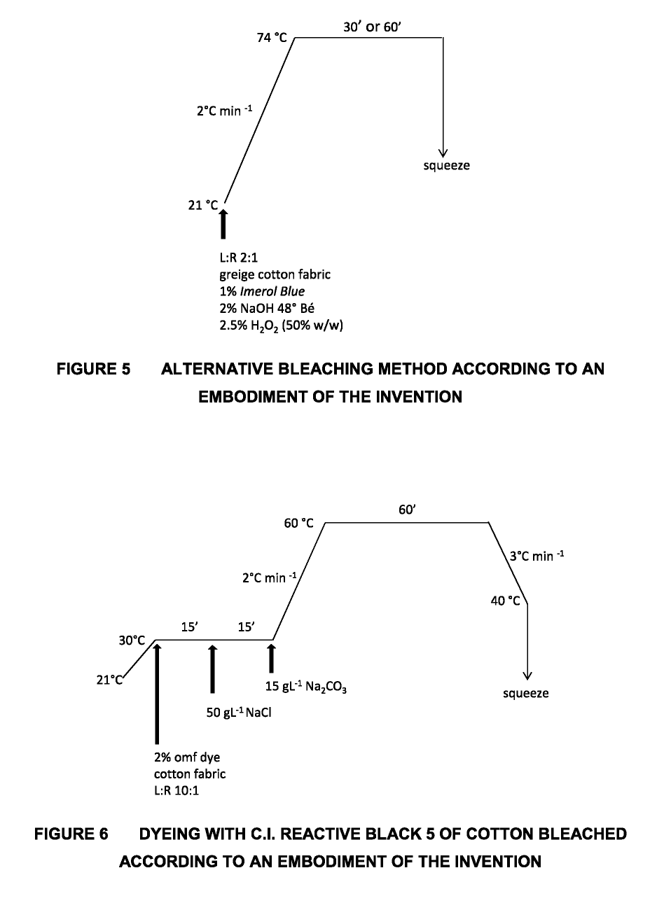

Greige cotton fabric was bleached following the procedure shown in FIG. 5, maintaining the bleaching temperature for 30 minutes and employing a solution comprising 1% Imerol® Blue, 2% NaOH 48 Be and 2.5% H₂O₂ (50% w/w) at a 2:1 liquor ratio. At the conclusion of the bleaching process, the sample was removed from the process bath, squeezed to remove surplus liquor and subjected to the rinsing procedure shown in FIG. 4, employing a liquor ratio of 5:1 for each of the three stages. The rinsed samples were squeezed and allowed to dry in the open air.

### Example 3

In this procedure, bleaching was carried out in a sealed, 1000 cm³ capacity, polypropylene plastic bag housed in a Miele® PT8257 tumble dryer. Prior to bleaching, the greige fabric was wetted-out with the bleaching solution which resulted in a water:fabric ratio of 2:1.

Greige cotton fabric was bleached following the procedure shown in FIG. 5, maintaining the bleaching temperature for 60 minutes employing a solution comprising 1% Imerol® Blue, 2% NaOH 48 Be and 2.5% H₂O₂ (50% w/w) at a 2:1 liquor ratio. At the conclusion of the bleaching process, the sample was removed from the process bath, squeezed to remove surplus liquor and subjected to the rinsing procedure shown in FIG. 4, employing a liquor ratio of 5:1 for each of the three stages. The rinsed samples were squeezed and allowed to dry in the open air.

### Dyeing Procedure

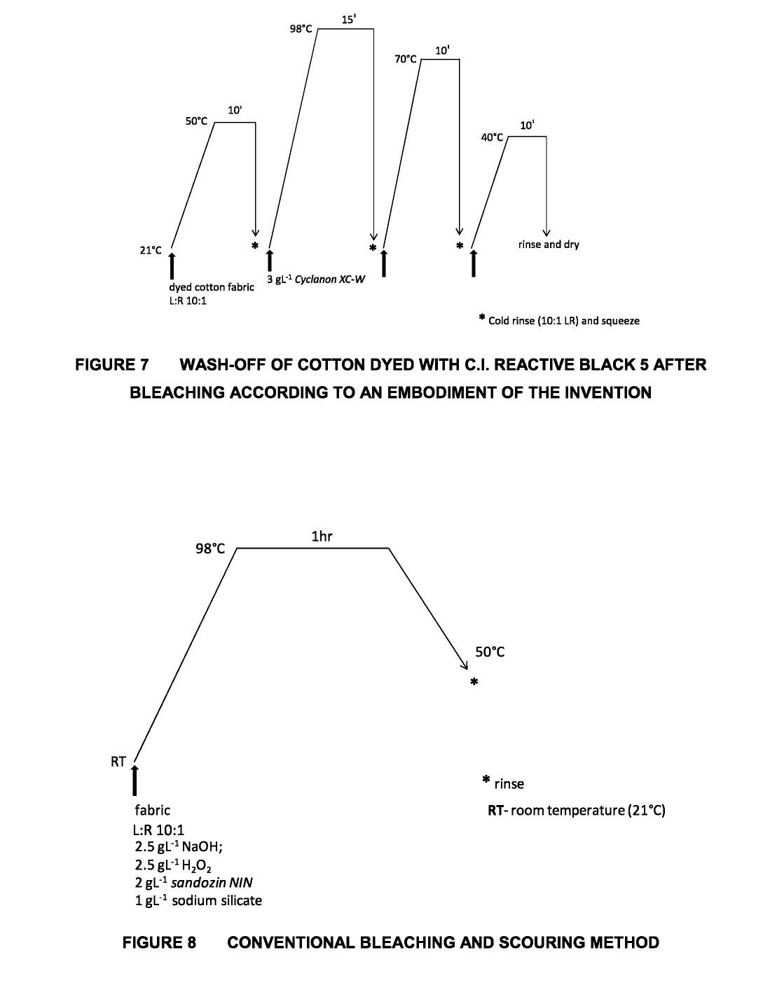

Bleached cotton fabric samples, obtained according to the methods of Comparative Example 1 and Examples 1, 2 and 3, were dyed with 2% (on mass of fibre) C.I. Reactive Black 5 in sealed, 300 cm³ capacity, stainless steel dyepots housed in a Roaches Pyrotec S dyeing machine using the method shown in FIG. 6, employing a liquor ratio of 10:1 in the presence 50 gL⁻¹ NaCl and 15 gL⁻¹ Na₂CO₃. On completion of the dyeing process, the sample was removed from the dyebath, squeezed to remove surplus dye liquor, and subjected to the wash-off procedure shown in FIG. 7, using a liquor ratio of 10:1 for each of the three stages. The washed-off dyeing was allowed to dry in the open air.

### Measurement of Whiteness Index (WI)

Whiteness Index values were obtained from tristimulus values calculated from the reflectance values of samples measured over the range 400 to 720 nm using a Datacolor Spectroflash 600 reflectance spectrophotometer under illuminant D65, employing a 10° standard observer with UV component included and specular component excluded. Samples were folded so as to realise two thicknesses and the average of four measurements was taken for each sample.

### Colour Measurement

The CIE colorimetric co-ordinates and colour strength (fₖ) values of the dyeings were calculated from the mean K/S values for each dyeing measured using a Datacolour Spectroflash 60 reflectance spectrophotometer from 400 to 700 nm under D65 illuminant, using a 10° standard observer with UV component included and specular component excluded. Samples were folded so as to realise two thicknesses and the average of four measurements was taken for each sample.

### Measurement of Water Absorbency (WA)

Water Absorbency was evaluated according to AATCC Test Method 79-2007. This test method is designed to measure the Water Absorbency of textiles by measuring the time it takes for a drop of water placed on the fabric surface to be completely absorbed into the fabric. A shorter elapsed time of water drop on cotton fabric indicates a better water absorbency.

### Results

### Whiteness Index

The WI values of bleached samples obtained using both the conventional and low-liquor bleaching processes are shown in Table 2, each experiment having been repeated four times; as such the WI values shown in Table 2 represent an average of four sample measurements.

TABLE 2
WHITENESS INDEX OF BLEACHED SAMPLES

| Treatment | Whiteness Index |
|---|---|
| Unbleached | 20.9 |
| Conventional Bleach; LR 10:1, 98° C., | 80.1 |
| 30 mins. (Comp. Example 1) | |
| Low Liquor Bleach; Dye Tube; LR 2:1, 98° C., | 81.6 |
| 30 mins. (Example 1) | |
| Low Liquor Bleach; PP Bag; LR 2:1, 74° C., | 81.7 |
| 30 mins. (Example 2) | |
| Low Liquor Bleach; PP Bag; LR 2:1, 74° C., | 84.4 |
| 60 mins. (Example 3) | |

### Water Absorbency

The Water Absorbency values recorded for bleached cotton fabrics obtained using both the conventional and modified low-liquor process are shown in Table 3.

TABLE 3
WATER ABSORBENCY VALUES OF BLEACHED SAMPLES

| | Water |
|---|---|
| Treatment | Absorbency/sec |
| Unbleached | 2-3 |
| Conventional Bleach; LR 10:1, 98° C., | <2 |
| 30 mins. (Comp. Example 1) | |
| Low Liquor Bleach; Dye Tube; LR 2:1, 98° C., | <2 |
| 30 mins. (Example 1) | |
| Low Liquor Bleach; PP Bag; LR 2:1, 74° C., | <2 |
| 30 mins. (Example 2) | |
| Low Liquor Bleach; PP Bag; LR 2:1, 74° C., | <2 |
| 60 mins. (Example 3) | |

### Dyeability

The colorimetric parameters of bleached samples that were dyed using 2% (on mass of fibre) C.I. Reactive Black 5, following the procedure described in FIG. 6, are set out in Table 4.

TABLE 4
COLORIMETRIC PARAMETERS OF DYED FABRIC SAMPLES

| Treatment | L* | a* | b* | C* | h° | fₖ | λₘₐₓ | ΔE_{CMC} |
|---|---|---|---|---|---|---|---|---|
| Conventional Bleach as per | 23.44 | −3.75 | −14.09 | −14.58 | 255.11 | 210.9 | 600 | — |
| Comp. Example 1 | | | | | | | | |
| Low Liquor Bleach as per | 23.66 | −3.26 | −14.88 | 15.24 | 257.66 | 206.2 | 600 | 0.7 |
| Example 1 | | | | | | | | |
| Low Liquor Bleach as per | 23.55 | −3.52 | −14.40 | 14.83 | 256.28 | 208.1 | 600 | 0.3 |
| Example 2 | | | | | | | | |
| Low Liquor Bleach as per | 23.48 | −3.33 | −14.15 | 14.54 | 256.77 | 207.7 | 600 | 0.3 |
| Example 3 | | | | | | | | |

### Comparative Example 2; Examples 4 and 5

Bleaching trials were carried-out on woven cotton greige fabric (100%) using both a conventional bleaching method and a low-liquor bleaching method according to embodiments of the invention. The resulting bleached samples were compared in terms of the degree of whiteness, water absorbency and dyeability.

### Fabrics

Cotton: scoured woven cotton fabric was obtained from Whaleys (Bradford, UK).

### Auxiliaries

The auxiliaries used are listed in Table 5

TABLE 5
AUXILIARIES EMPLOYED IN COMPARATIVE
EXAMPLE 2 AND EXAMPLES 4 AND 5

| Trade name | Type | Manufacturer |
|---|---|---|
| Hostapal NIN fl | non-ionic surfactant: | Clariant |
| k | polymer based on branched C13 | |
| | fatty alcohols (ethoxylated) | |
| Merpol A | Non-ionic, low foaming | Sigma-Aldrich |
| surfactant | wetting agent: based on | |
| | ethylene oxide condensate | |
| Bactosol SAP | hybrid catalase enzyme; | Clariant |
| liq c | catalyses peroxide | |
| | decomposition | |

### Comparative Example 2

Conventionally bleached samples were obtained by carrying out bleaching operations in sealed, 300 cm³ capacity, stainless steel dyepots housed in a Roaches Pyrotec S dyeing machine.

100% greige cotton fabric was bleached using the procedure shown in FIG. 12 employing a solution comprising 10 gL⁻¹ H₂O₂ (50% w/w), 2.5 gL⁻¹ NaOH, 1 gL⁻¹ Na₂SiO₃, and either 2 gL⁻¹ Hostapal NIN or 2 gL⁻¹ Merpol A, at a 10:1 liquor ratio. At the conclusion of the bleaching process the sample was removed from the process bath, squeezed to remove surplus liquor and subjected to the multiple rinsing procedure shown in FIG. 2, employing a liquor ratio of 10:1 for each of the three rinsing stages. The rinsed samples were squeezed and either allowed to dry in the open air or dyed using a dyeing procedure as described above in relation to Comparative Example 1 and Examples 1, 2 and 3.

### Example 4

In this procedure, bleaching was carried out in sealed, 300 cm³ capacity, stainless steel dyepots housed in a Roaches Pyrotec S dyeing machine.

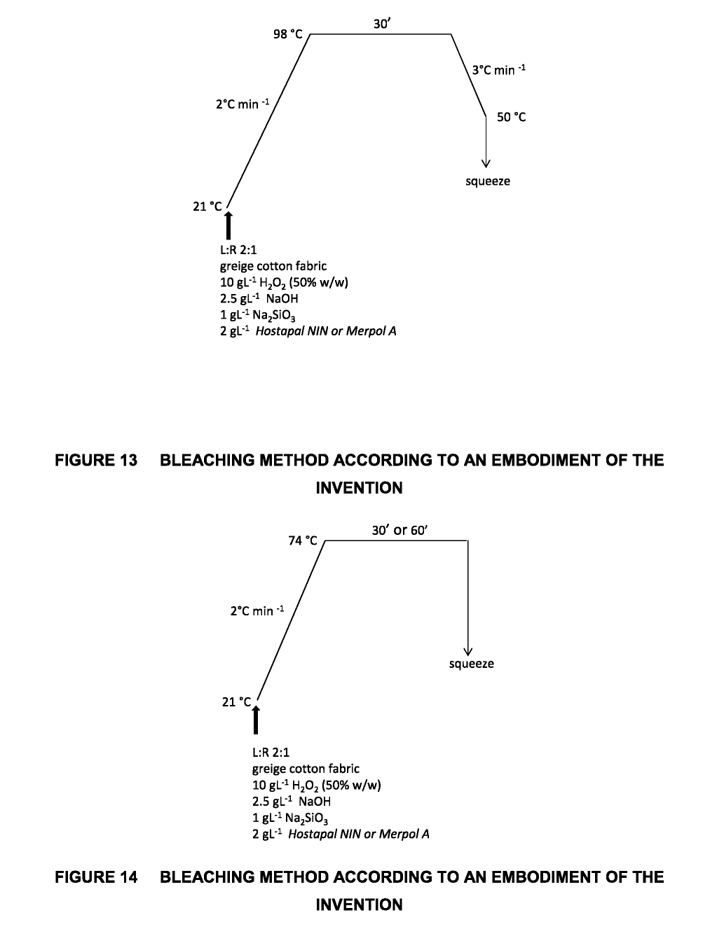

100% greige cotton fabric was bleached following the procedure shown in FIG. 13 employing a solution comprising 10 gL⁻¹ H₂O₂ (50% w/w), 2.5 gL⁻¹ NaOH, 1 gL⁻¹ Na₂SiO₃, and either 2 gL⁻¹ Hostapal N/N or 2 gL⁻¹ Merpol A, at a liquor ratio of 2:1. At the end of the bleaching process the sample was removed from the process bath, squeezed to remove surplus liquor and subjected to the multiple rinsing procedure shown in FIG. 4, employing a liquor ratio of 5:1 for each stage. The rinsed samples were squeezed and either allowed to dry in the open air or dyed using a dyeing procedure as described above in relation to Comparative Example 1 and Examples 1, 2 and 3.

### Example 5

In this procedure, bleaching was carried out in a sealed, 1000 cm³ capacity, polypropylene plastic bag housed in a Miele® PT8257 tumble dryer. Prior to bleaching the greige fabric was wetted-out with the bleaching solution which resulted in a water:fabric ratio (L:R) of 2:1.

100% greige cotton fabric was bleached following the procedure shown in FIG. 14 employing a solution 10 gL⁻¹ H₂O₂ (50% w/w), 2.5 gL⁻¹ NaOH, 1 gL⁻¹ Na₂SiO₃, and either 2 gL⁻¹ Hostapal N/N or 2 gL⁻¹ Merpol A, at a 2:1 liquor ratio and for time periods of 30 minutes or 60 minutes. At the end of the bleaching process the sample was removed from the process bath, squeezed to remove surplus liquor and subjected to the multiple rinsing procedure shown in FIG. 4, employing a liquor ratio of 5:1 for each stage. The rinsed samples were squeezed and either allowed to dry in the open air or dyed using a dyeing procedure as described above in relation to Comparative Example 1 and Examples 1, 2 and 3.

### Results

The Whiteness Index (WI), water absorbency (WA) and colour measurement procedures followed were as described above.

The letters H and M represent samples obtained using either 2 gL⁻¹Hostapal N/N or 2 gL⁻¹ Merpol A as the bleaching auxiliary respectively.

### Whiteness Index (WI)

The WI values of bleached samples obtained using both the conventional process of Comparative Example 2 and low-liquor bleaching process of Examples 4 and 5 are shown in Table 6. Each example in this section was repeated and as such the WI values shown in Table 6 represent an average of two sample measurements.

TABLE 6
WHITENESS INDEX VALUES OF BLEACHED SAMPLES

| Treatment | WI |
|---|---|
| Untreated WI = 20.9 | |
| Conventional | |
| LR 10:1, 98° C., 30′ (Comparative Example 2); H | 82.6 |
| LR 10:1, 98° C., 30′ (Comparative Example 2); M | 83.9 |
| low-liquor | |
| Dyetubes LR 2:1, 98° C., 30′ (Example 4); H | 80.3 |
| Dyetubes LR 2:1, 98° C., 30′ (Example 4); M | 81.3 |
| Tumble dryer; LR 2:1, 74° C., (Example 5); 30′ H | 73.6 |
| Tumble dryer; LR 2:1, 74° C., (Example 5); 30′ M | 75.2 |
| Tumble dryer; LR 2:1, 74° C., (Example 5); 60′ H | 79.7 |
| Tumble dryer; LR 2:1, 74° C., (Example 5); 60′ M | 79.2 |

### Water Absorbency (WA)

Table 7 shows the WA values recorded for bleached cotton fabrics obtained using both the conventional process of Comparative Example 2 and low-liquor bleaching process of Examples 5 and 6.

TABLE 7
WA VALUES RECORDED FOR BLEACHED SAMPLES

| Treatment | WA |
|---|---|
| Untreated | 2-3 s |
| Conventional | |
| LR 10:1, 98° C., 30′ (Comparative Example 2); H | <2 s |
| LR 10:1, 98° C., 30′ (Comparative Example 2); M | <2 s |
| Modified low-liquor | |
| Dyetubes LR 2:1, 98° C., 30′ (Example 4); H | <2 s |
| Dyetubes LR 2:1, 98° C., 30′ (Example 4); M | <2 s |
| Tumble dryer; LR 2:1, 74° C., (Example 5); 30′ H | <2 s |
| Tumble dryer; LR 2:1, 74° C., (Example 5); 30′ M | <2 s |
| Tumble dryer; LR 2:1, 74° C., (Example 5); 60′ H | <2 s |
| Tumble dryer; LR 2:1, 74° C., (Example 5); 60′ M | <2 s |

### CONCLUSIONS

It was observed that there was very little difference in terms of the whiteness index, water absorbency and colour strength (fₖ value) obtained for samples that had been bleached conventionally at a 10:1 liquor ratio compared to samples which had been bleached using the low-liquor ratio process, despite the fact the low-liquor process used at least ˜80% less water, energy and chemicals (i.e. a corollary of using a 2:1 liquor ratio as opposed to a conventional 10:1 liquor ratio). In addition, the results obtained indicated that the low liquor ratio bleaching process gave satisfactory results even when carried out at 74° C. rather than the conventional temperature of 98° C.

In view of the fact that the low liquor ratio bleaching process of the invention uses smaller amounts of bleaching chemicals, it is possible to reduce the amount of water that must be employed to remove residual bleaching chemicals from the bleached material. Thus, the rinsing process employed for the low-liquor bleaching process used 50% less rinse water compared to the rinse process used for the conventionally bleached samples (i.e. a corollary of using a 5:1 liquor ratio for each rinsing stage compared to the 10:1 liquor ratio employed in the conventional rinsing process).

### B. Bleaching and Scouring Procedures

### Comparative Example 3

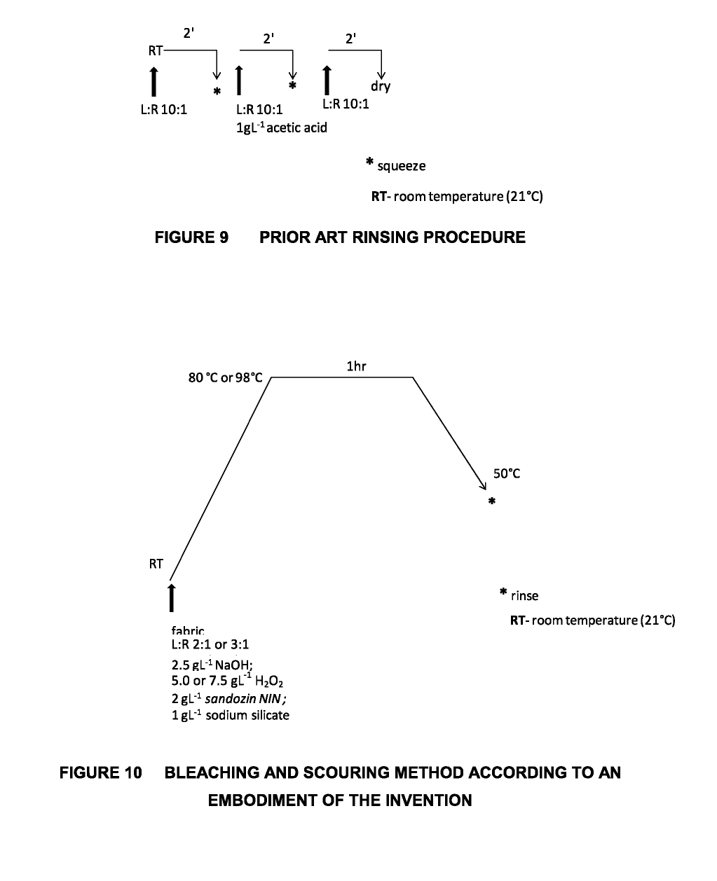

Knitted, unscoured, unbleached polyester/cotton (50/50 blend) fabrics were treated in sealed 300 cm³ capacity, stainless steel dyepots housed in a Roaches Pyrotec S dyeing machine at 98° C. for 1 hour according to the procedure shown in FIG. 8, employing a liquor to goods ratio of 10:1 using 2.5 gL⁻¹ NaOH, 2.5 gL⁻¹ H₂O₂ (35 wt %), 2 gL⁻¹ Sandozin N/N (non-ionic surfactant) and 1 gL⁻¹ sodium silicate (stabiliser). At the end of the combined scouring and bleaching process the sample was removed from the process bath, squeezed to remove surplus liquor and subjected to the multiple rinsing procedure shown in FIG. 9, employing a liquor ratio of 10:1 for each stage. Rinsed samples were squeezed and allowed to dry in the open air.

### Example 6

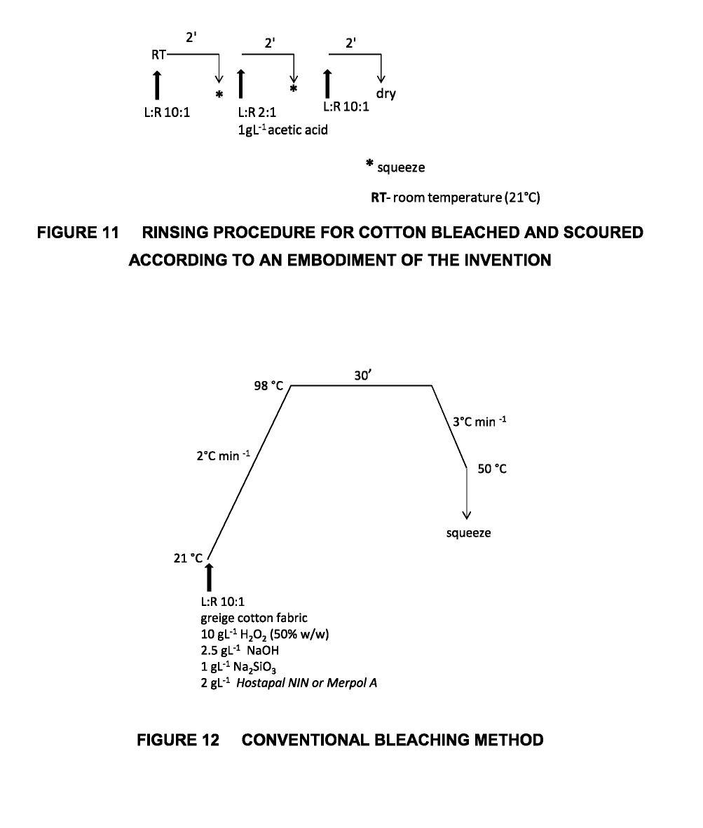

Knitted, un-scoured, unbleached polyester/cotton (50/50 blend) fabrics were treated in sealed, stainless steel dyepots housed in a Roaches Pyrotec S dyeing machine at 80° C. and 98° C. for between 15 and 60 minutes, employing liquor to goods ratios of 2:1 and 3:1, using 2.5 gL⁻¹ NaOH, both 5.0 and 7.5 gL⁻¹ H₂O₂, 2 gL⁻¹ Sandozin N/N (non-ionic surfactant) and 1 gL⁻¹ sodium silicate (stabiliser) according to the procedure illustrated in FIG. 10. At the end of the combined scouring and bleaching process the sample was removed from the process bath, squeezed to remove surplus liquor and subjected to the multiple rinsing procedure shown in FIG. 11. Rinsed samples were squeezed and allowed to dry in the open air.

### Results

Table 8 shows that the use of low liquor ratios increased the whiteness of the unscoured, unbleached fabric, as expressed in terms of Whiteness Index, at both the 2:1 and 3:1 liquor ratios used. Table 8 also shows that levels of whiteness comparable to that achieved using the conventional scouring and bleaching process could be achieved at low liquor ratios, depending on the time, temperature and amount of peroxide used.

TABLE 8
COLORIMETRIC PARAMETERS OF BLEACHED
AND SCOURED POLYESTER/COTTON SAMPLES

| | Time/ | Liquor | 5 gL⁻¹ | 7.5 gL⁻¹ | |
|---|---|---|---|---|---|
| Sample | mins. | Ratio | H₂O₂ | H₂O₂ | WI |
| Untreated | — | — | — | — | 24.4 |
| Conventional; 98° C.; Liquor Ratio 10:1; 60 minutes; | | | | | 75.2 |
| 2.5 gL⁻¹ H₂O₂ | | | | | |
| 80° C. | 15 | 2:1 | 63.3 | 65.08 | 63.3 |
| | 30 | | 69.2 | 71.39 | 69.2 |
| | 45 | | 72.9 | 69.52 | 72.9 |
| | 60 | | 70.2 | 72.10 | 70.2 |
| 98° C. | 15 | | 71.7 | 66.25 | 71.7 |
| | 30 | | 72.5 | 74.63 | 72.5 |
| | 45 | | 73.4 | 74.15 | 73.4 |
| | 60 | | 73.9 | 73.58 | 73.9 |
| 80° C. | 15 | 3:1 | 70.0 | — | 70.0 |
| | 30 | | 73.8 | — | 73.8 |
| | 45 | | 75.5 | — | 75.5 |
| | 60 | | 73.9 | — | 73.9 |
| 98° C. | 15 | | 74.1 | — | 74.1 |
| | 30 | | 79.7 | — | 79.7 |
| | 45 | | 79.4 | — | 79.4 |
| | 60 | | 75.5 | — | 75.5 |

Although only one concentration of peroxide was used for the conventional scour/bleach process (i.e. 2.5 gL⁻¹), two concentrations of peroxide were used for the low liquor ratio trials, namely 5 and 7.5 gL⁻¹. However, in terms of the amounts of H₂O₂ used, since the concentration of bleach is measured in terms of volume of water employed (i.e. liquor ratio) then, assuming that 1 kg of polycotton was to be bleached, Table 9 shows that the conventional process which employed a 10:1 liquor ratio would use 25 g H₂O₂ whereas, in the cases of the two lower liquor ratio values used, even though higher concentrations of peroxide were used (i.e. 5 and 7.5 gL⁻¹), lower amounts of peroxide would be employed; the 2:1 liquor ratio would require 5 g, and the 3:1 liquor ratio 7.5 g of peroxide. A similar pattern follows for the amounts of NaOH and sodium silicate used at the different liquor ratios, as is also shown in Table 9. Clearly, even when using 7.5 gL⁻¹ H₂O₂ at a 3:1 liquor ratio, less peroxide is used than that employed in the conventional process (which uses 2.5 gL⁻¹ peroxide at a 10:1 liquor ratio). Thus, at low liquor ratios (i.e. 2:1 or 3:1), less chemicals are used than with the conventional process, and it is also possible to employ a higher concentration of peroxide (7.5 gL⁻¹) whilst still reducing chemical usage.

TABLE 9
AMOUNTS OF CHEMICALS REQUIRED
AS A FUNCTION OF LIQUOR RATIO

| Liquor | 2.5 gL⁻¹ | 5 gL⁻¹ | 7.5 gL⁻¹ | 1 gL⁻¹ |
|---|---|---|---|---|
| ratio | H₂O₂ | H₂O₂ | H₂O₂ | Na₂SiO₃ |
| 10:1 | 25 | — | — | 10 |
| 3:1 | — | 15 | 21 | 3 |
| 2:1 | — | 10 | 14 | 2 |

Throughout the description and claims of this specification, the words “comprise” and “contain” and variations of them mean “including but not limited to”, and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

The reader's attention is directed to all papers and documents which are filed concurrently with or previous to this specification in connection with this application and which are open to public inspection with this specification, and the contents of all such papers and documents are incorporated herein by reference.

1-60. (canceled)

61. A method for the application of a bleaching agent to a substrate, said method comprising the treatment of the substrate in an aqueous system comprising a liquid bleaching agent in a closed container, said treatment being carried out at a ratio of liquor to substrate which does not exceed 3:1.

62. A method as claimed in claim 61 wherein said treatment comprises the wetting out of the substrate using an aqueous liquor comprising said liquid bleaching agent, said wetting out being carried out at a ratio of liquor to substrate which does not exceed 3:1.

63. A method as claimed in claim 61 wherein said treatment comprises spraying either one or both sides of said substrate with an aqueous liquor comprising said liquid bleaching agent so as to provide a ratio of liquor to substrate which does not exceed 3:1.

64. A method as claimed in claim 61 wherein said treatment comprises the wetting out of the substrate with water and the subsequent treatment of the wetted out substrate with the liquid bleaching agent.

65. A method as claimed in claim 61 wherein said ratio of liquor to substrate does not exceed 2.5:1.

66. A method as claimed in claim 61 wherein the substrate comprises a textile substrate.

67. A method as claimed in claim 61 wherein said liquid bleaching agent comprises hydrogen peroxide.

68. A method as claimed in claim 61 wherein said liquid bleaching agent is added to the treatment system at a level in the region of 1-5% w/w of the substrate being treated.

69. A method as claimed in claim 61 wherein said aqueous systems comprise at least one auxiliary agent selected from alkalis, wetting agents, detergents and sequestering agents.

70. A method as claimed in claim 69 wherein said treatment comprises a bleaching and scouring treatment and said at least one auxiliary agent comprises at least one scouring agent wherein said scouring agent comprises at least one non-ionic surfactant and at least one stabilizing agent.

71. A method as claimed in claim 69 wherein said at least one auxiliary agent is selected from wetting agents, detergents and sequestering agents which are added at a combined level in the region of 0.5-20.0 gL⁻¹.

72. A method as claimed in claim 69 wherein said at least one auxiliary agent is selected from alkaline agents which are added in amounts of 1-30 gL⁻¹.

73. A method as claimed in claim 61 wherein said aqueous system is substantially free from one or more foaming agents selected from the list consisting of: anionic foaming agents such as partially carboxymethylated alkylpolyglycolethers, arylpolyglycolethers, alkylarylpolyglycolethers or arylalkylpolyglycolethers, alkanesuplhonates, alkylbenzenesulponates and alkylnaphthalene sulphonates, primary or secondary alkylsulphates, alkylpolyglycol-ether sulphates, alkyl-phenylpolyglycol-ether sulphates and dialkylphenylpolyglycol-ether sulphates, sulphonated or sulphated oils, fatty acid taurides and fatty acid-sulphato-ethylamides; non-ionic agents such as water-soluble adducts obtained by reacting 8 to 50 moles of ethylene oxide with a fatty alcohol, a fatty acid, a fatty acid amide, an alkylmercaptan or an alkylphenol; cationic agents such as the adducts obtained by reacting 8 to 100 moles of ethylene oxide with a fatty alkylamine or a fatty alkylpoly-amide or their quaternized derivatives; or amphoteric agents such as fatty acid-sulphato-ethylamino-ethylamides, fatty acid γ-sulpho-β-hydroxy-propylamino-ethylamides, the monosulphated or disulphated adducts of 8 to 100 moles of ethylene oxide and a fatty alkylamine or a fatty alkylpolyamine.

74. A method as claimed in claim 61 wherein the aqueous system is substantially free from compounds of the formula (I):
R—O—(C₃H₆O)ₙ—(C₂H₄₀)ₘ—H (I)
wherein n is 0 or a number between 1 and 4, m is a number between 2 and 10 and R stands for a C₈-C₁₅ alkyl group, the group comprising at least one carbon atom which is directly connected to three other carbon atoms.

75. A method as claimed in claim 61 wherein said method is carried out at temperatures in the range of from 20° to 140° C.

76. A method as claimed in claim 61 wherein the closed container containing said aqueous system is agitated.

77. A method as claimed in claim 61 which additionally includes a rinsing procedure for the removal of surplus bleaching and other agents following application of said agents to said substrate, wherein said rinsing procedure comprises not more than three rinse treatments of said substrate with aqueous liquor following said application.

78. A method as claimed in claim 77 wherein said rinsing procedure comprises a three-stage process comprising performing, in order, the steps of:
a. A first rinse of the bleached substrate with aqueous liquor in a closed container;
b. A second rinse of the bleached substrate with aqueous liquor in a closed container; and
c. A final rinse of the bleached substrate with aqueous liquor in a closed container.

79. A method as claimed in claim 78 wherein the ratio of liquor to substrate does not exceed 5:1 in any of steps (a), (b) or (c).

80. A method as claimed in claim 77 wherein the aqueous liquors used for one or more of the rinsing stages consist of water.

81. A method as claimed in claim 77 wherein the aqueous liquors used for one or more of the rinsing stages include at least one rinsing agent selected from neutralizing agents and bleach removers.
